(19) United States
(12) Patent Application Publication
(10) Pub. No.: US 2018/0335645 A1
(43) Pub. Date: Nov. 22, 2018

(54) OPHTHALMIC LENS DESIGNING DEVICE AND OPHTHALMIC LENS DESIGNING METHOD

(71) Applicant: HON HAI PRECISION INDUSTRY CO., LTD., New Taipei (TW)

(72) Inventor: WEN-KAI LI, New Taipei (TW)

(21) Appl. No.: 15/636,776

(22) Filed: Jun. 29, 2017

(30) Foreign Application Priority Data
May 17, 2017 (CN) 201710349107.0

(51) Int. Cl. G02C 7/02; G06F 17/50; G02C 7/06

(52) U.S. Cl. CPC G02C 7/028; G02C 7/02; G02C 7/066; G06F 17/50

(57) ABSTRACT

A method for designing an ophthalmic lens includes establishing a B-spline curved surface of the ophthalmic lens. A merit function is established according to a preset dioptric power distribution on the target curved surface and a curvature distribution corresponding to the preset dioptric power distribution. A plurality of control points of the B-spline curved surface is selected. Coordinates of all the selected control points are substituted into the merit function, and a value of the merit function is calculated. Whether the calculated value is less than or equal to a preset value is determined. If yes, the optimized B-spline curved surface is determined as representing the target curved surface. Otherwise, at least one selected control point is moved to optimize the B-spline curved surface.

### FIELD

The subject matter relates to an ophthalmic lens designing device and an ophthalmic lens designing method.

### BACKGROUND

Ophthalmic progressive addition lenses (PALs) are widely used for treatment of presbyopia. The progressive surface of the PAL comprises a distant region, a near region, and an intermediate region smoothly connected between the distant region and the near region. The progressive surface provides a gradual and continuous increase in dioptric power from the distant region to the intermediate region, and to the near region.

Thus, when the dioptric power of one region needs to be changed, the dioptric power of other regions also needs to be changed to ensure the continuous increase in dioptric power on the progressive surface. However, it may result in a geometrical discontinuity on the surface of the PAL.

### BRIEF DESCRIPTION OF THE DRAWINGS

Implementations of the present technology will now be described, by way of example only, with reference to the attached figures.

FIG. 1 is a block diagram of an exemplary embodiment of an ophthalmic lens designing device.

FIG. 2 is a flowchart of an exemplary embodiment of an ophthalmic lens designing method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

In general, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic modules, such as gates and flip-flops, and may comprise programmable modules, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series, and the like.

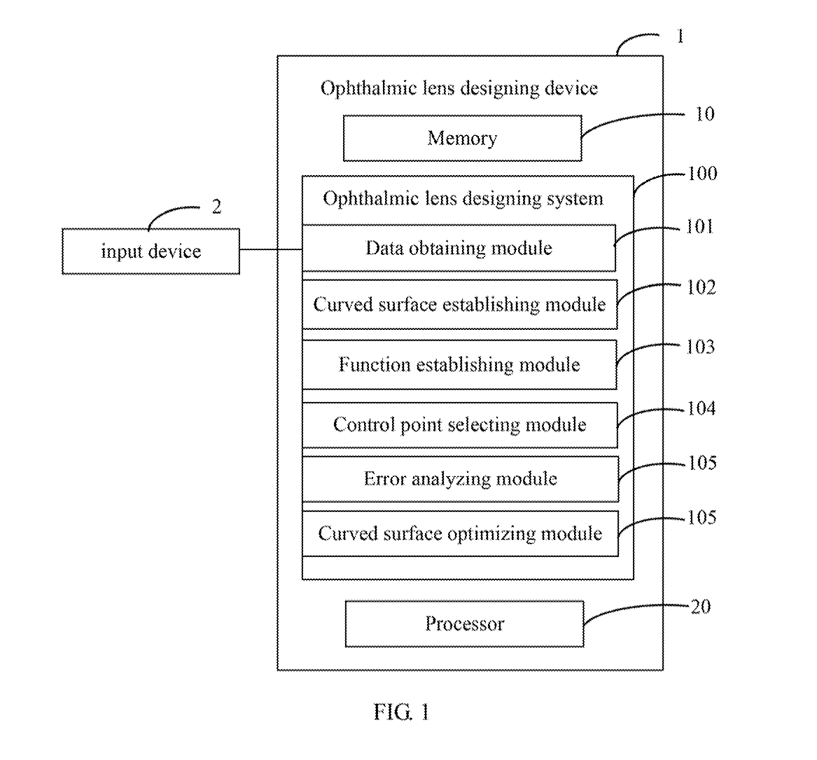

FIG. 1 illustrates an exemplary embodiment of an ophthalmic lens designing device 1 comprising a memory 10 and at least one processor 20. The memory 10 stores an ophthalmic lens designing system 100 for designing a particular curved surface (target curved surface) for the ophthalmic lens. The ophthalmic lens can be an eyeglass, a contact lens, or an intraocular lens. More specifically, the ophthalmic lens can be a progressive addition lens.

The ophthalmic lens designing system 100 comprises a data obtaining module 101, a curved surface establishing module 102, a function establishing module 103, a control point selecting module 104, an error analyzing module 105, and a curved surface optimizing module 106. The modules 101-106 may comprise computerized instructions in the form of one or more programs that are stored in the memory 10 and executed by the at least one processor 20. A detailed description of each module will be given in the following paragraphs.

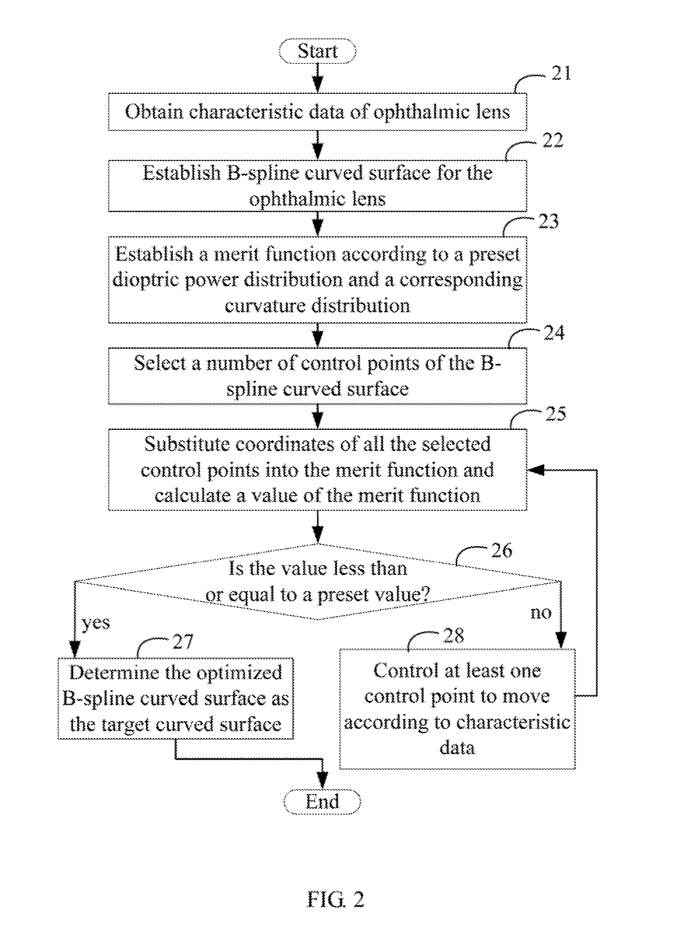

FIG. 2 illustrates an exemplary embodiment of an ophthalmic lens designing method. The method is provided by way of example, as there are a variety of ways to carry out the method. The method described below can be carried out using the configurations illustrated in FIG. 1, for example, and various elements of these figures are referenced in explaining example method. Each block shown in FIG. 2 represents one or more processes, methods, or subroutines, carried out in the example method. Furthermore, the illustrated order of blocks is illustrative only and the order of the blocks can change. Additional blocks can be added or fewer blocks may be utilized, without departing from this disclosure. The example method can begin at block 21.

At block 21, the data obtaining module 101 obtains characteristic data of the ophthalmic lens. In at least one exemplary embodiment, the characteristic data comprises dioptric power, corridor length or width, size of the distant region, size of the near region, and any combination thereof. The ophthalmic lens designing device 1 can be connected to an input device 2. The input device 2 is for input of the characteristic data, thereby allowing the data obtaining module 101 to obtain the characteristic data. The input device 2 can be a keyboard or a mouse.

At block 22, the curved surface establishing module 102 establishes a B-spline curved surface for the ophthalmic lens. The B-spline curved surface is not yet used at this stage to fully approximate the target curved surface. The designer can design the B-spline curved surface according to the shape of any common ophthalmic lens. The B-spline curved surface is geometrically continuous, and has curvatures that continuously changes among different segments of the B-spline curved surface. Thus, the B-spline curved surface can meet the actual requirements of the target curved surface.

At block 23, the function establishing module 103 establishes a merit function according to a preset dioptric power distribution on the target curved surface and a curvature distribution corresponding to the preset dioptric power distribution. The merit function can decrease an error between the B-spline curved surface and the target curved surface. That is, the merit function can optimize the B-spline curved surface to cause the optimized B-spline curved surface to fully approximate the target curved surface.

The dioptric power distribution can be designed by any well-known method. For example, when the ophthalmic lens is a progressive addition lens that comprises a distant region, a near region, and an intermediate region smoothly connected between the distant region and the near region, the dioptric power distribution can gradually and continuously increase from the distant region to the intermediate region and the near region.

The function establishing module 103 calculates the curvature distribution according to the dioptric power distribution. Such a calculation/determination of the curvature is known in the art.

The merit function can be described as a function F:

F=∫[a×(H²−G)+b×(H−P)²)]dA

H=[(1+f_{y}²)×fₓₓ−2×fₓ×f_{y}×f_{xy}+(1+fₓ²)×f_{yy}]/(2×g³)

G=(fₓₓ×f_{yy}−f_{xy})/g⁴

g=(1+fₓ²+f_{y}²)^{0.5}

Wherein, “a” and “b” represent weight factors, f(x,y) represents the target curved surface, fₓ represents differentiating the target curved surface f(x,y) with respect to x, f_{y} represents differentiating the target curved surface f(x,y) with respect to y, fₓₓ represents differentiating the target curved surface f(x,y) with respect to x twice, f_{yy} represents differentiating the target curved surface f(x,y) with respect to y twice, f_{xy} represents differentiating the target curved surface f(x,y) with respect to x and then y, and P(x,y) represents the dioptric power distribution on the target curved surface. Wherein, H, G, and g have no special meanings, only to simplify the merit function F. Thus, the merit function F can represent the dioptric power and the curvature of any coordinate (x,y) of the target curved surface.

At block 24, the control point selecting module 104 selects a number of control points of the B-spline curved surface. The number of the selected control points can be varied as needed.

At block 25, the error analyzing module 105 substitutes coordinates of all the selected control points into the merit function, and calculates a value of the merit function.

At block 26, the error analyzing module 105 determines whether the calculated value is less than or equal to a preset value. If yes, the procedure goes to block 27; otherwise the procedure goes to block 28.

At block 27, the curved surface optimizing module 106 determines the optimized B-spline curved surface as the target curved surface.

At block 28, the curved surface optimizing module 106 controls at least one selected control point to move according to obtained characteristic data, thereby optimizing the B-spline curved surface as a full approximation of the target curved surface. Then, the block 25 is repeated until the calculated value of the merit function is less than or equal to the preset value. The obtained characteristic data can be used to determine a moving direction and a moving distance of the selected control point.

In at least one exemplary embodiment, the preset value can be varied according to need. For example, the preset value can be 0 or 0.01.

With the above configuration, when the value of the merit function is greater than the preset value, at least one selected control point of the B-spline curved surface is moved to optimize the B-spline curved surface. Therefore, the optimized B-spline curved surface can fully approximate the target curved surface according to the merit function. The B-spline curved surface is applied, which is geometrically continuous, and has curvatures that continuously changes among different segments of the B-spline curved surface. Thus, this can prevent a geometrical discontinuity being generated on the target curved surface of the ophthalmic lens.

The embodiments shown and described above are only examples. Many details are often found in the art such as the other features of a protection case. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

1. An ophthalmic lens designing device for designing a target curved surface of an ophthalmic lens, the device comprising:
at least one processor; and
a memory coupled to the at least one processor and storing one or more programs, wherein when executed by the at least one processor, the one or more programs causing the at least one processor to:
establish a B-spline curved surface for the ophthalmic lens;
establish a merit function according to a preset dioptric power distribution on the target curved surface and a curvature distribution corresponding to the preset dioptric power distribution;
select a plurality of control points of the B-spline curved surface;
substitute coordinates of the plurality of selected control points into the merit function, and calculate a value of the merit function;
determine whether the calculated value being less than or equal to a preset value; and
determine the optimized B-spline curved surface as the target curved surface when the calculated value being less than or equal to a preset value, and control at least one of the plurality of selected control points to move when the calculated value being greater than the preset value to optimize the B-spline curved surface.

2. The ophthalmic lens designing device of claim 1, wherein the merit function is described as a function F:
F=∫[a×(H²−G)+b×(H−P)²)]dA
H=[(1+f_{y}²)×fₓₓ−2×fₓ×f_{y}×f_{xy}+(1+fₓ²)×f_{yy}]/(2×g³)
G=(fₓₓ×f_{yy}−f_{xy})/g⁴
g=(1+fₓ²+f_{y}²)^{0.5}
wherein, “a” and “b” represent weight factors, f(x,y) represents the target curved surface, fₓ represents differentiating the target curved surface f(x,y) with respect to x, f_{y} represents differentiating the target curved surface f(x,y) with respect to y, fₓₓ represents differentiating the target curved surface f(x,y) with respect to x twice, f_{yy} represents differentiating the target curved surface f(x,y) with respect to y twice, f_{xy} represents differentiating the target curved surface f(x,y) with respect to x and then y, and P(x,y) represents the dioptric power distribution on the target curved surface.

3. The ophthalmic lens designing device of claim 1, wherein the one or more programs further cause the at least one processor to obtain characteristic data of the ophthalmic lens, thereby control the at least one of the plurality of selected control points to move according to the obtained characteristic data.

4. The ophthalmic lens designing device of claim 3, wherein the ophthalmic lens is a progressive addition lens that comprises a distant region and a near region, the characteristic data comprises dioptric power, corridor length or width, size of the distant region, size of the near region, and any combination thereof.

5. The ophthalmic lens designing device of claim 1, wherein the ophthalmic lens is a progressive addition lens that comprises a distant region, a near region, and an intermediate region smoothly connected between the distant region and the near region, and the dioptric power distribution gradually and continuously increases from the distant region to the intermediate region and the near region

6. An ophthalmic lens designing method for designing a target curved surface of an ophthalmic lens, the ophthalmic lens designing method comprising:
establish a B-spline curved surface for the ophthalmic lens;
establish a merit function according to a preset dioptric power distribution on the target curved surface and a curvature distribution corresponding to the preset dioptric power distribution;
select a plurality of control points of the B-spline curved surface;
substitute coordinates of the plurality of selected control points into the merit function, and calculate a value of the merit function;
determine whether the calculated value being less than or equal to a preset value; and
determine the optimized B-spline curved surface as the target curved surface when the calculated value being less than or equal to a preset value, and control at least one of the plurality of selected control points to move when the calculated value being greater than the preset value to optimize the B-spline curved surface.

7. The ophthalmic lens designing method of claim 6, wherein the merit function is described as a function F:
F=∫[a×(H²−G)+b×(H−P)²)]dA
H=[(1+f_{y}²)×f_{y}²)×fₓₓ−2×fₓ×f_{y}×f_{xy}+(1+fₓ²)×f_{yy}]/(2×g³)
G=(fₓₓ×f_{yy}−f_{xy})/g⁴
g=(1+fₓ²+f_{y}²)^{0.5}
wherein, “a” and “b” represent weight factors, f(x,y) represents the target curved surface, fₓ represents differentiating the target curved surface f(x,y) with respect to x, f_{y} represents differentiating the target curved surface f(x,y) with respect to y, fₓₓ represents differentiating the target curved surface f(x,y) with respect to x twice, f_{yy} represents differentiating the target curved surface f(x,y) with respect to y twice, f_{xy} represents differentiating the target curved surface f(x,y) with respect to x and then y, and P(x,y) represents the dioptric power distribution on the target curved surface.

8. The ophthalmic lens designing method of claim 6, further comprising:
obtaining characteristic data of the ophthalmic lens;
wherein the plurality of selected control points is controlled to move according to the obtained characteristic data.

9. The ophthalmic lens designing method of claim 8, wherein the characteristic data comprises dioptric power, corridor length or width, size of the distant region, size of the near region, and any combination thereof.

10. The ophthalmic lens designing method of claim 6, wherein the ophthalmic lens is a progressive addition lens that comprises a distant region, a near region, and an intermediate region smoothly connected between the distant region and the near region, and the dioptric power distribution gradually and continuously increases from the distant region to the intermediate region and the near region.
